(19) United States
(12) Patent Application Publication
(10) Pub. No.: US 2026/0175420 A1
(43) Pub. Date: Jun. 25, 2026

(54) HYBRID SAFETY SYSTEM AND METHODS FOR USE WITH POSITIONERS CROSS-REFERENCE TO RELATED APPLICATIONS

(71) Applicant: Vectis Automation, LLC, Loveland, CO (US)

(72) Inventors: Andrew Akey, Windsor, CO (US); Joshua Pawley, Windsor, CO (US); Douglas Rhoda, Timnath, CO (US); Marcus Yakawich, Windsor, CO (US); Todd Scarpella, Fort Collins, CO (US); Brendan DeJonge, Fort Collins, CO (US)

(73) Assignee: Vectis Automation, LLC, Loveland, CO (US)

(21) Appl. No.: 19/356,145

(22) Filed: Oct. 12, 2025

Related U.S. Application Data
(60) Provisional application No. 63/706,663, filed on Oct. 12, 2024.

(51) Int. Cl. B25J 9/16; B25J 9/00

(52) U.S. Cl. CPC B25J 9/1633; B25J 9/0096; B25J 9/1666

(57) ABSTRACT

A highly mobile multi-station collaborative robot fabrication system for the assembly, construction, fabrication, and/or the completion of weldments or performing cutting operations in fabrication shop or factory environments or on large structures in difficult to access or elevated locations and methods of deploying and operating the system and including a hybrid working environment which integrates traditional non-collaborative work holding positioners and welding or cutting system elements and collaborative robotic work processing implements to create a safe working environment or work zone for an operator comprising each and every novel feature disclosed or suggested herein.

### CROSS-REFERENCE TO RELATED APPLICATIONS

This application claims priority to U.S. Provisional Patent Application Ser. No. 63/706,663 filed on Oct. 12, 2024, the entire contents of which are incorporated herein by reference.

### FIELD OF THE INVENTION

The present invention relates generally to fabrication systems for use in manufacturing operations. More specifically, the present invention relates to hybrid safety systems for use with positioners in manufacturing environments to prevent injury to a programmer or to an operator. In particular, the present invention relates to a hybrid safety system integrated into a readily re-deployable collaborative robotic manufacturing system having a non-collaborative positioner to create a hybrid working environment that allows for manipulation of complex parts while still allowing observation by a programmer or operator when the positioner is not moving and methods for using the hybrid safety system to produce precise structural components from raw work materials therewith.

### BACKGROUND OF THE INVENTION

The fabrication of assemblies formed of metal structural elements and components having complex non-linear shapes, joint surfaces and edges requires the preparation and processing of the structural elements and components, for example, beveling the edges thereof, by skilled metal processing workers or by using complex, highly-automated systems designed to generate the components' complex non-linear shapes, joint surfaces and precise edges mandated for quality joint fit up. The structural components may be manufactured using both ferrous and non-ferrous base metal alloys. The physical properties, chemical composition, sensitivity to oxidation and heat transfer characteristics of various alloys demand close attention to materials processing techniques used to fabricate a wide variety of structures and products. As noted above, joint fit up is critical to the fabrication of multicomponent products, particularly to the fabrication of multicomponent products that are adaptable to automated, high-volume production processes. Completed structures may be assembled by using mechanical fasteners, adhesives, materials joining techniques such as welding and brazing or a combination of some or all of the foregoing. Exemplary structures extend at one end of the spectrum from commonplace household appliances, furniture, exercise and lawn maintenance equipment to expensive and sophisticated space and airborne platforms, military equipment, scientific apparatus, chemical processing systems and medical devices fabricated from exotic metals. The list is endless.

A knowledgeable machinist or welder may assess the requirements of a particular job based upon prior experience and may adjust one or more machining input variables such as material and machine tool selection, cutting speed, cut sequencing and so forth. Proper weld joint preparation likewise requires detailed knowledge of materials characteristics such as thermal conductivity, cutting process selection, preheat and post heat requirements as needed to prevent cracking, and other variables to achieve the desired edge configuration with the precision required for proper assembly or to achieve the desired weld penetration and weld bead configuration from both a functional and an aesthetic perspective.

Optimal weld quality depends not only on proper welding parameter settings, but also on physical consistency of the path and angle of the weld torch, intangibles which may be influenced by an individual welder's skills; variable situational influences including concentration, fatigue, and health issues; and operating environment factors such as heat, humidity, lighting and ventilation. These factors are particularly influential on weld quality where the welding process is performed with a hand-held electrode or torch. The same considerations apply to cutting operations.

Automated welding and cutting systems have been developed to enhance weld joint quality, consistency, and productivity by minimizing adverse effects of variable welding process parameter input and human performance. Automated systems typically replace the historical hand-held and guided cutting torch in cutting applications and, in welding applications, coated or “stick” electrode process with automated continuous wire feed systems such as Gas Metal Arc Welding (GMAW), flux-cored arc welding (FCAW), gas tungsten arc welding (GTAW) or submerged arc welding (SAW) systems. The afore-mentioned automated processes may be used in connection with work-holding fixtures, weld head positioners and robot systems that can be programmed for specific welding applications. Nonetheless, if an operator enters incorrect parameter settings or fails to notice technical process irregularities during the course of fabricating a weldment, inevitably, scrap and rework will be the result. Even more serious is the possibility of catastrophic field failure of a welded structure, for example a bridge truss or an airframe, both of which may result in personal injury or loss of life.

Depending upon the application, automated robot welding and cutting systems can be massive assemblies requiring substantial acquisition and installation capital expenditures, dedicated floor space, safety systems, utility inputs for electrical power, hydraulics and/or cooling water; and overhead cranes or lateral material conveyance systems for work material and finished assembly transport. Although some prior art systems are designed for smaller manufacturing operations and may be moved from one location to another via forklift and pickup truck, a welding cell is not amenable for use with different welding systems (GMAW, GTAW, SAW, for example), high mix, low volume production, or movement within a manufacturing facility without potentially disrupting other operations.

Consequently, manufacturers are under tremendous stress to increase welding productivity through automation but currently have only risky and costly options to do so. Traditional robot welding solutions are a significant financial risk, bulky, dangerous, and expensive, with long delivery times, significant set-up time and cost, and what operations managers view as “well, no-turning-back now” risk. While larger corporations may be able to bear the cost and risk of traditional automation, the smaller shops that make up 75% of America's 250,000+ manufacturers are prohibited by the high capital investment requirements from availing themselves of the advantages offered by either partially or fully automated systems. Moreover, the problems associated with the fabrication of large structures is exacerbated by the challenge involved and difficulty of remotely deploying cobots or robots. Few practical means of welding on larger structures exist that do not require a large extremely precise machine to position the cobot or robot. These machines are typically very expensive and are typically anchored to the concrete floor of a building or shop. Traditional industrial robot installations also require safety features to isolate the robot from human contact or to otherwise protect human operators from being crushed by the powerful robotic arms during an operational sequence.

In response to the above needs, relatively inexpensive, mobile and versatile welding systems have been developed which are capable of producing weldments of the highest quality and that may also be and set up and operated by less experienced individuals in both high mix, low volume production environments and also on massive assemblies where the fabrication system may be positioned in uncomfortably elevated positions. These mobile and versatile fabrication systems include collaborative robots or cobots which are designed to operate safely in a shared space in close proximity with human operators. Collaborative robotic fabrication systems provide welding and cutting systems that can be set up and programmed intuitively by an operator without the need for significant computer programming and coding training. They also address a need for a readily re-deployable and transportable automated fabrication system that may be installed in the field or in a manufacturing operation and moved from one worksite to another by a human operator without significant labor or rigging or substantial acquisition and installation capital expenditures, dedicated floor space, or ancillary internal support and operating systems.

While the aforementioned mobile collaborative systems are a significant improvement over the comparatively massive and immobile prior art automated robot welding and cutting systems, the more advanced mobile collaborative robot systems use a traditional robot with one or more work holding positioners, a safeguarding fence, light curtains, scanners, as well as additional safety devices to create a safety zone around the workspace to protect an operator from serious injury. These systems, when in automatic mode, always shut down all equipment when the safety zone is broken by someone entering therein to observe welding or cutting operations.

In view of the above, it is evident that a need exists for a mobile collaborative robot system which intergrades a non-collaborative positioner with a collaborative robot to create a working environment that allows for manipulation of complex parts while still allowing observation by a programmer or operator when the positioner is not moving and to simply load and/or unload work materials such as piece parts while the system is still running without having to wait for the system to finish its task before interrupting the system. The present invention addresses aforementioned needs in the art as well as other needs, all of which will become apparent to those skilled in the art from the accompanying disclosure.

### SUMMARY OF THE INVENTION

In accordance with the embodiments of the present invention, a highly-mobile collaborative robot fabrication system is disclosed having a hybrid working environment for performing welding or cutting tasks related to weld joint preparation and the initial assembly, construction, fabrication and/or completion of weldments including tack welding together components of a weldment, performing the welding tasks associated with a given weldment, and/or completing a partially finished welding project.

In an embodiment, a highly-mobile collaborative robot fabrication system includes a hybrid working environment which integrates traditional non-collaborative work holding positioners and welding or cutting system elements and collaborative robotic work processing implements to create a safe working environment or work zone for an operator.

In another embodiment, a highly-mobile collaborative robot fabrication system includes a hybrid working environment in the form of a safety zone which allows an operator to enter the safety zone and, in response thereto, transitions the system into a collaborative operation mode temporarily as long as a work-holding positioner and any other non-collaborative system component is not in use.

In yet another embodiment, a highly-mobile collaborative robot fabrication system includes a hybrid working environment in the form of a safety zone which allows for manipulation of complex parts while still allowing observation of ongoing welding or cutting operations by a programmer or operator when the positioner is not moving.

In still another embodiment, a highly-mobile collaborative robot fabrication system includes a hybrid working environment in the form of a safety zone which allows an operator to load and unload parts while the system is still running, thereby minimizing down time.

In another embodiment, a highly-mobile collaborative robot fabrication system having a hybrid working environment in the form of a safety zone includes a user interface or a teach pendant adapted to allow work material processing programming to be completed in an intuitive and graphical manner without requiring significant and specific education, training or computer programming and coding experience or skills.

In yet another embodiment, a highly-mobile collaborative robot fabricating system having a hybrid working environment in the form of a safety zone includes a mobile platform or cart adapted to be relocated without significant labor and/or rigging to bring the fabricating system to the work.

In still another embodiment, a highly-mobile collaborative robot fabricating system having a hybrid working environment in the form of a safety zone includes a programmable collaborative robot arm adapted to hold fabricating implements, the collaborative robot arm being operatively connected to a moveable base or cabinet, and a mobile platform or cart adapted to stow and transport the collaborative robot welding arm, the moveable base or cabinet, and fabricating system accessory equipment.

In another embodiment, a highly-mobile collaborative robot fabrication system includes a hybrid working environment in the form of a safety zone and a work holding positioner operatively connected to a top or upper work surface of a mobile platform or cart.

In yet another embodiment, a highly-mobile collaborative robot fabrication system includes a hybrid working environment in the form of a safety zone and a dual axis work holding positioner operatively connected to and extending outwardly away from a side panel or face of a mobile platform or cart.

In another embodiment, the programmable collaborative robot arm includes a safety feature or system built into a robot control system and the robot arm itself.

In another embodiment, a highly-mobile collaborative robot fabrication system having a hybrid working environment in the form of a safety zone provides enhanced production efficiency by allowing an operator to set up and complete more tasks through parallel and simultaneously performed operational steps and by shifting repetitive, monotonous welding tasks to the collaborative robot welding system.

In an embodiment, a highly-mobile collaborative robot welding system having a hybrid working environment in the form of a safety zone is disclosed for performing welding tasks related to joining together raw work materials of various shapes and thicknesses via a welding process.

In an embodiment, a highly-mobile collaborative robot cutting system having a hybrid working environment in the form of a safety zone is disclosed for performing cutting tasks related to cutting raw work materials of various shapes and thicknesses.

These and other features, aspects and advantages of the present invention will become apparent to those skilled in the art from the following detailed description of preferred embodiments taken in connection with the accompanying drawings, which are summarized briefly below.

### BRIEF DESCRIPTION OF THE DRAWINGS

Referring now to the attached drawings which form a part of this original disclosure:

FIG. 1 is a front side elevation view of the elements of a highly-mobile collaborative robot fabrication system having a collaborative robotic work processing implement in the form of a welding torch and a non-collaborative work holding positioner operatively secured to a gridded planar worksurface in accordance with an embodiment of the present invention;

FIG. 2 is a right side elevation view of the highly-mobile collaborative robot fabrication system of FIG. 1 in accordance with an embodiment of the present invention;

FIG. 3 is a rear side elevation view of the highly-mobile collaborative robot fabrication system of FIGS. 1 and 2 in accordance with an embodiment of the present invention;

FIG. 4 is a left side elevation view of the highly-mobile collaborative robot fabrication system of FIGS. 1-3 in accordance with an embodiment of the present invention;

FIG. 5 is a top plan view of the highly-mobile collaborative robot fabrication system of FIGS. 1-4 in accordance with an embodiment of the present invention;

FIG. 6 a bottom plan view of the highly-mobile collaborative robot fabrication system of FIGS. 1-5 is in accordance with an embodiment of the present invention;

FIG. 7 is a rear top perspective view of the highly mobile collaborative robot fabrication system of FIGS. 1-6 illustrating a mobile base including a corner-mounted operator protection safety system in accordance with an embodiment of the present invention;

FIG. 8 is a front top perspective view of the highly-mobile collaborative robot fabrication system of FIGS. 1-7 in accordance with an embodiment of the present invention;

FIG. 9 is a right front bottom perspective view of the highly-mobile collaborative robot fabrication system of FIGS. 1-8 in accordance with an embodiment of the present invention;

FIG. 10 is a right rear bottom perspective view of the highly-mobile collaborative robot fabrication system of FIGS. 1-9 in accordance with an embodiment of the present invention;

FIG. 11 is a top plan view of the highly-mobile collaborative robot fabrication system of FIGS. 1-10 illustrating a safety zone and perimeter in accordance with an embodiment of the present invention;

FIG. 12 is a front top perspective view of the highly-mobile collaborative robot fabrication system, safety zone and perimeter shown in FIG. 11;

FIG. 13 is a rear top perspective view of the highly-mobile collaborative robot fabrication system, safety zone and perimeter shown in FIGS. 11 and 12;

FIG. 14 is a front side elevation view of the elements of a highly-mobile collaborative robot fabrication system having a collaborative robotic work processing implement in the form of a welding torch operatively secured to a top planar surface of a supporting cabinet and a non-collaborative dual axis work holding positioner operatively secured to a front panel surface of the supporting cabinet in accordance with an embodiment of the present invention;

FIG. 15 is a rear side elevation view of the elements of the highly-mobile collaborative robot fabrication system of FIG. 14 in accordance with an embodiment of the present invention;

FIG. 16 is a right side elevation view of the elements of the highly-mobile collaborative robot fabrication system of FIGS. 14 and 15 in accordance with an embodiment of the present invention;

FIG. 17 is a left side elevation view of the elements of the highly-mobile collaborative robot fabrication system of FIGS. 14-16 in accordance with an embodiment of the present invention;

FIG. 18 is a top plan view of the elements of the highly-mobile collaborative robot fabrication system of FIGS. 14-17 in accordance with an embodiment of the present invention;

FIG. 19 is a bottom plan view of the elements of the highly-mobile collaborative robot fabrication system of FIGS. 14-18 in accordance with an embodiment of the present invention;

FIG. 20 is a top left front perspective view of the elements of the highly-mobile collaborative robot fabrication system of FIGS. 14-19 in accordance with an embodiment of the present invention;

FIG. 21 is a bottom front right perspective view of the elements of the highly-mobile collaborative robot fabrication system of FIGS. 14-20 in accordance with an embodiment of the present invention;

FIG. 22 is a top left rear perspective view of the elements of the highly-mobile collaborative robot fabrication system of FIGS. 14-21 in accordance with an embodiment of the present invention;

FIG. 23 is a bottom right rear perspective view of the elements of the highly-mobile collaborative robot fabrication system of FIGS. 14-22 in accordance with an embodiment of the present invention;

FIG. 24 is a top plan view of the highly-mobile collaborative robot fabrication system of FIGS. 14-23 illustrating a safety zone and perimeter in accordance with an embodiment of the present invention;

FIG. 25 is a front top perspective view of the highly-mobile collaborative robot fabrication system, safety zone and perimeter shown in FIG. 24 in accordance with an embodiment of the present invention;

FIG. 26 is a flow diagram of the operating sequence steps of a highly-mobile collaborative robot systems of FIGS. 1 and 14 illustrating system response steps to an interruption of the safety zone perimeter in accordance with an embodiment of the present invention.

FIG. 27A is a flow diagram of the operating sequence steps of the highly-mobile collaborative robot fabrication systems of FIGS. 1-25 in automatic and manual modes in accordance with an embodiment of the present invention;

FIG. 27B is a flow diagram of the operating sequence steps of a highly-mobile collaborative robot in automatic and manual modes without a non-collaborative work holding positioner in accordance with an embodiment of the present invention; and

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claim and its equivalents.

### Overview of System Operation

A highly-mobile collaborative robot fabrication system configured as a welding or a cutting system having a separate non-collaborative positioner in accordance with an embodiment of the present invention addresses the afore-mentioned needs of the industry by providing a welding or cutting system that may be taken to the work material, set up, and placed in production in less than a few hours. As the term is used herein, “highly-mobile” refers to a fabrication system that is capable of being moved from one location to another by an operator quickly and easily without the aid of ancillary equipment such as tractors, forklifts or overhead cranes or rigging systems. The highly-mobile collaborative robot fabrication system includes a mobile platform or cart which supports a collaborative robot arm adapted to hold and guide a welding or cutting implement in response to a control system material processing program, also referred to herein as a cobot, programming and control systems and select ancillary equipment such as by way of example and not of limitation, a wire feed system, all of which is positioned on the cart. Cobots are lightweight in comparison to traditional robots. Accordingly, the mobile platform or cart and the fabricating equipment positioned thereon may be moved into position adjacent a large assembly or selectively and securely placed in position directly on the assembly for performing welding operations. Contrasted with the weight of much larger robotic systems, the lighter weight of the collaborative robot welding system of the instant invention makes this deployment method possible.

The highly-mobile collaborative robot welding system further includes a user interface or a teach pendant adapted to allow control system programming to be completed for any given job in an intuitive and graphical manner without requiring significant and specific education, training or computer programming/coding experience or skills. Accordingly, in a scarce labor market, where an extreme shortage of skilled welders exists, the collaborative robot welding system of the present invention permits manufacturers of welded products to meet the high demand for those products economically.

In operation, the operator/programmer either brings the work materials to be cut or welded to the collaborative robot, for example in fabrication shop or factory environments, or, alternatively, brings the robot to the work material. If the collaborative robot is taken to the work material, the welder is plugged into available single phase or three phase wall power and the collaborative robot is plugged into an available 120V outlet. Once both devices are powered on, the operator/programmer starts positioning the collaborative robot for the work material which is held in a non-collaborative positioner operatively connected to the cart. The first positions that the operator/programmer will teach are clearance moves of the robot arm, designated as “AirMove's” to position the robot in preparation for the cutting or welding task at hand. The primary means of moving the collaborative robot and the welding gun to the work material is via a programming button that releases the robot into a hand-guided jogging mode where the operator/programmer can push/pull the robot into the appropriate position. When the operator/programmer starts positioning the collaborative robot, he/she ensures they have a blueprint or a material processing procedure document that will be used to identify the start point and the size and type of welding or the shape and location of the cutting to be performed on the work material. If the desired work material will vary in positional location or the collaborative robot is moved to the work material, tactile searching/sensing is needed to ensure the trajectory of the robot is properly placed in the joint or at the cut considering this variation. If one of these conditions exists, the operator/programmer plans out the searching scheme and weld or cut path offsets if needed.

Traditional robot systems use a traditional non-collaborative robot, i.e., a robot that operates independently and which is typically used in environments where human interaction is limited or not required. Non-collaborative robotic systems require safeguarding fence, light curtains, scanners, as well as additional safety devices to establish a safety zone or safety barrier surrounding the robot and the work material being processed. These systems, when in automatic mode, always shut down all equipment when the safety zone is broken. The novel system of the present invention integrates a non-collaborative positioner with the elements of a collaborative robot fabrication system including a safety feature built in to a collaborative robot to create a working environment within the safety zone that allows for manipulation of complex parts while still allowing observation by a programmer or operator when the positioner is not moving. As the term is used herein, hybrid working environment shall mean the working environment created by the integration of a non-collaborative positioner with a collaborative robot fabrication system within the safety zone generated by elements of the collaborative robot fabrication system. An operator may enter the safety zone and cause the system to slow down into a collaborative operation mode temporarily as long as the positioner and any other non-collaborative device is not in operation. This technique advantageously enables traditional non-collaborative systems to be integrated with collaborative robotic systems to allow for observation of welding or cutting operations for quality control purposes or even loading and unloading parts while the system is still running without having to wait for the fabrication cycle to finish, thereby minimizing down time.

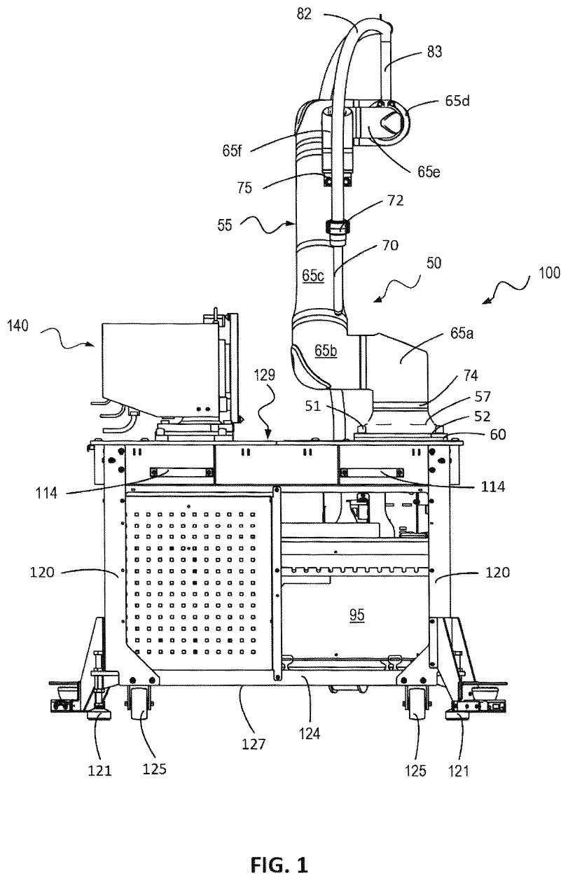

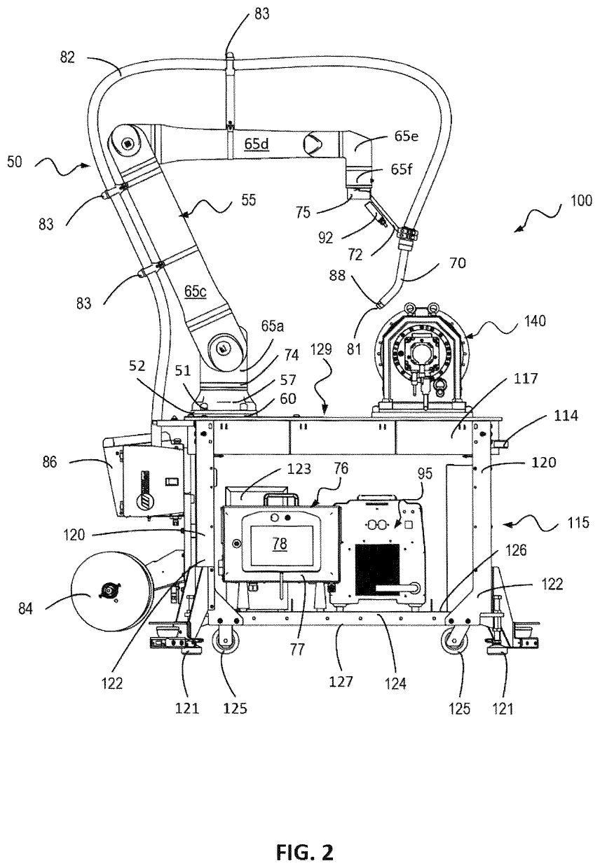

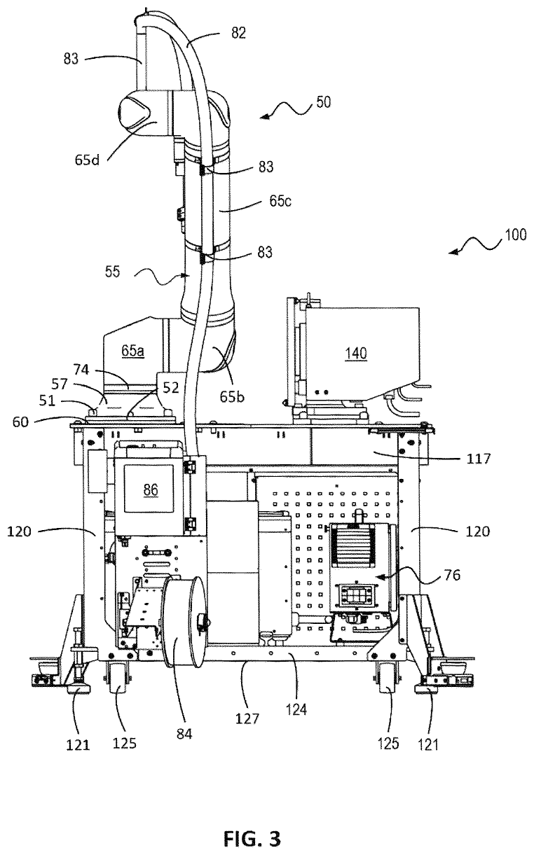

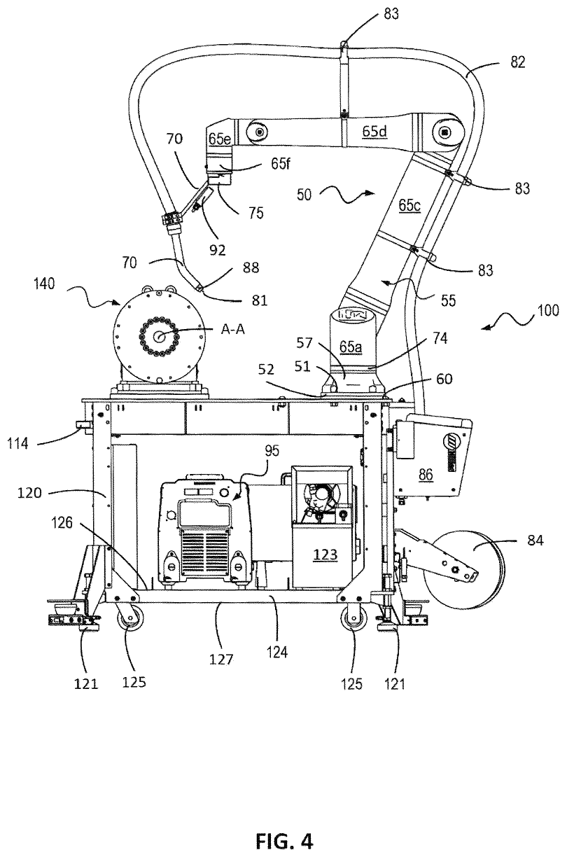

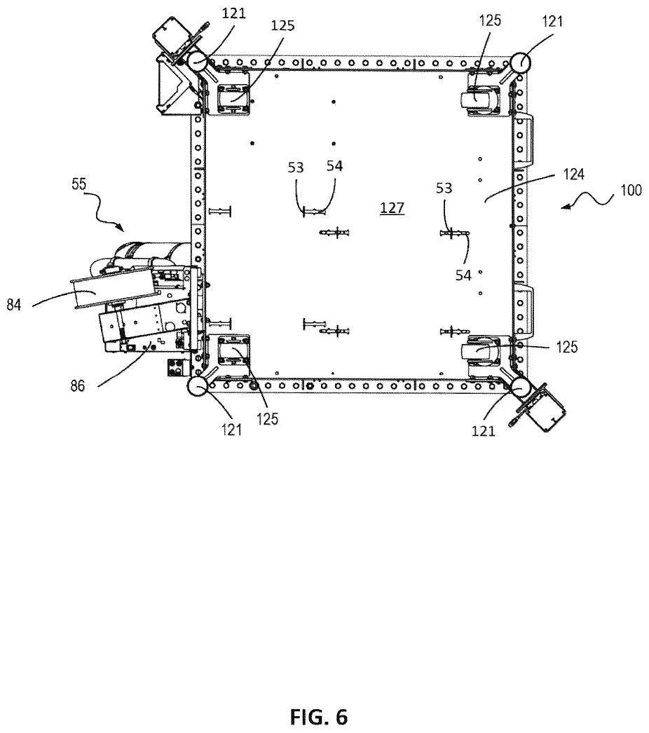

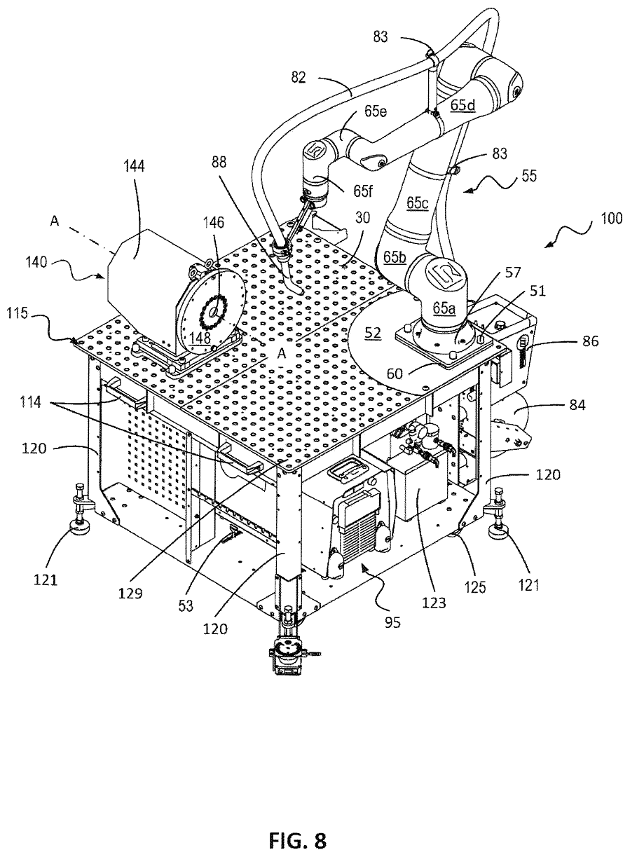

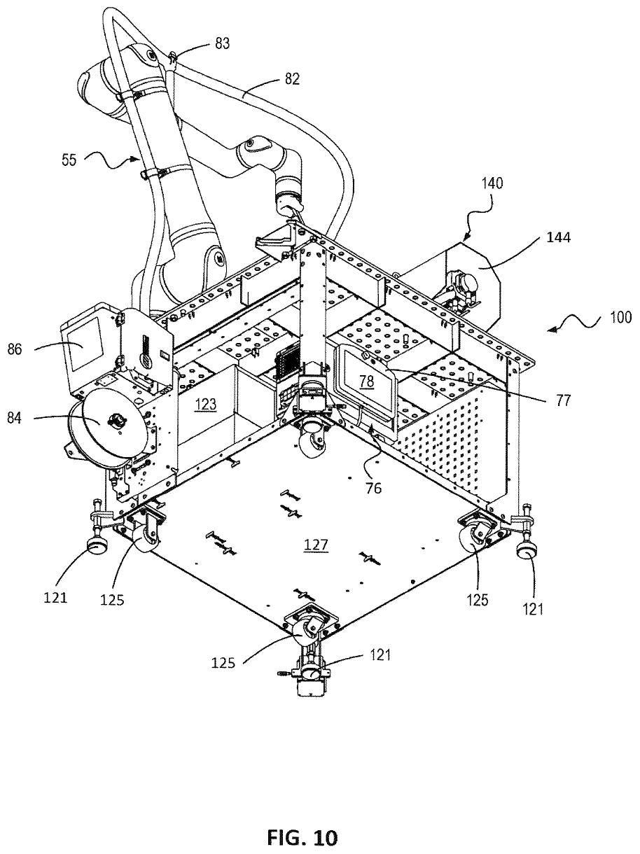

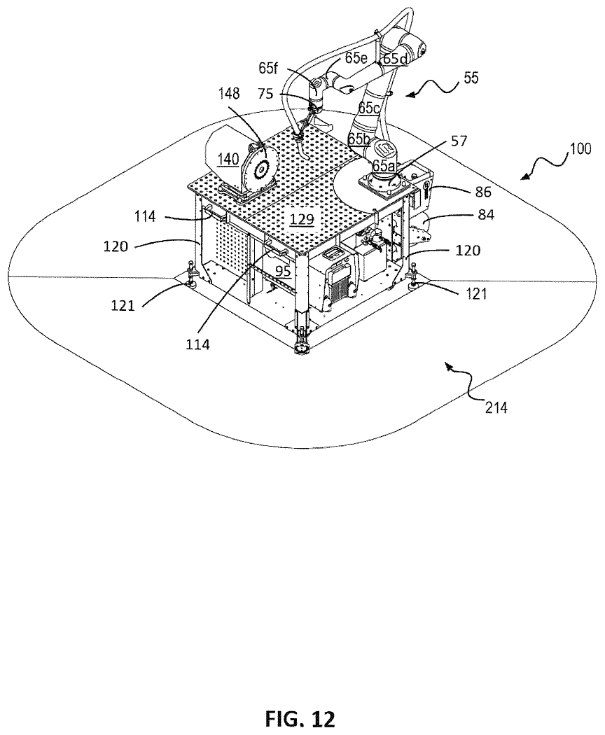

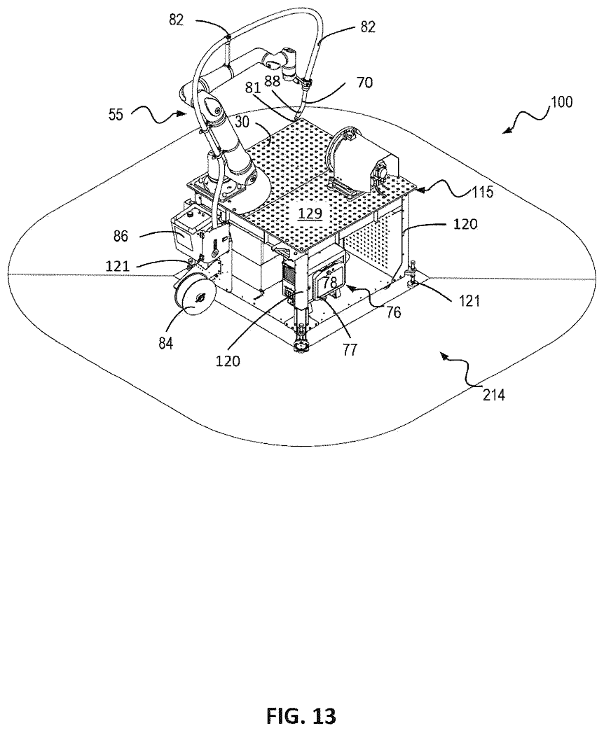

Referring initially to FIGS. 1-13, an exemplary highly-mobile collaborative robot fabrication system having a hybrid working environment for performing welding or cutting tasks related to weld joint preparation and the initial assembly, construction, fabrication and/or completion of weldments is shown generally at the number 100. For purposes of illustration, the system 100 is configured as a welding system; however, it is to be understood that it may be configured as a cutting system without departing from the scope of the present invention. The welding system includes a mobile platform, base, or cart 115, as the terms may be used interchangeably herein, having a frame 117, a plurality of supporting legs 120 operatively connected to the frame, each of the plurality of supporting legs including a levelling device or foot 121 attached thereto, a bottom or lower storage area or platform 124 operatively connected to each of the plurality of supporting legs, the bottom or lower storage area or platform including an upper or top surface 126, a lower or bottom surface 127, and a plurality of wheels or casters 125 secured to the bottom surface. a gridded upper work surface or table 129, and one or more handles 114 operatively connected to the frame 117 and extending outwardly therefrom, the handles being adapted to permit an operator to move the system to a designated location for performing fabrication operations such as welding or cutting, as the case may be. The gridded upper work surface includes a plurality of apertures 30 formed therein, each of the apertures being adapted to releasably receive a clamp or other securement device for holding a workpiece, fixture or weld assembly in a fixed position during the performance of a welding sequence using the welding system.

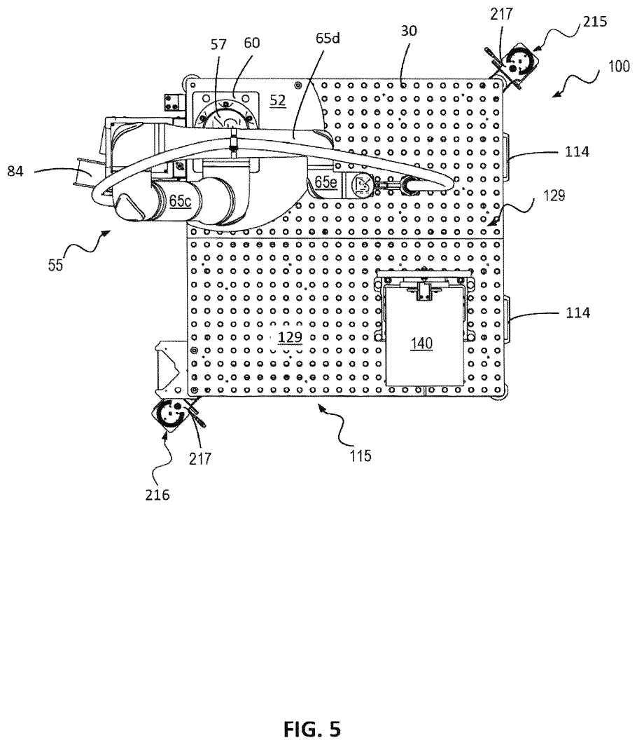

The welding system 100 further includes at least one programmable collaborative robot system 50 (known in the art as a cobot), such as a Universal Robots™ UR10e collaborative industrial robot. However, it is to be understood that collaborative robot systems either specifically designed and built for individual applications or other generally commercially available collaborative robot systems may also be used without departing from the scope of the present invention. The collaborative robot system comprises a robot arm 55 having a first or proximal end 74 operatively connected to a first base 57, and a second or distal end 75. A second base or base plate 52 is secured to or formed integrally with the table 129 (FIG. 5), the second base or base plate being adapted to provide a solid and stable platform for mounting the robot arm to the gridded upper work surface or table 129 of the mobile base or cart. An electrically isolating pad 60 is disposed intermediate the first base and the second base or base plate, the electrically isolating pad being structured and arranged to isolate the cobot electrically from the mobile platform 115. The robot arm includes a plurality of arm segments 65a-65f sequentially pivotally and/or rotatably interconnected to one another and structured and arranged to have a reach length or distance which depends upon the size of the robot arm selected for use in the system and the lengths of its individual segments. A material processing implement in the form of a welding or cutting implement or torch 70 is secured via an attachment 72 to the distal end 75 of the robot arm, the implement being universally positionable and translatable along a preselected weld or cut path in response to instructions from a robot control system or robot controller shown generally at 76. The robot control system includes teach pendant 77 and application programming interface (API) display 78. In the embodiments of FIGS. 1-13, by way of example and not of limitation, the implement 70 is depicted in the form of a welding torch representative of the type used in Gas Metal Arc Welding (GMAW) processes; however, it is to be understood that the system of the present invention may be used with any materials joining or cutting process without departing from the scope of the present invention. It is to be understood that the system 100 may be used for cutting applications by replacing the welding implement 70 with a plasma cutting torch or other cutting implements needed for a particular cutting application.

Welding consumables such as protective shielding gas, cutting gas, granular flux material and welding wire 81 are delivered to the welding implement via conduit or welding torch bundle 82 secured to the robot arm by conduit or bundle management brackets 83. The wire is stored in a suitable wire storage apparatus such as a drum or, by way of example and not of limitation, on a wire spool 84 and fed by a wire feed mechanism 86 from the spool through the conduit or bundle and to a weld joint assembly via a weld nozzle 88.

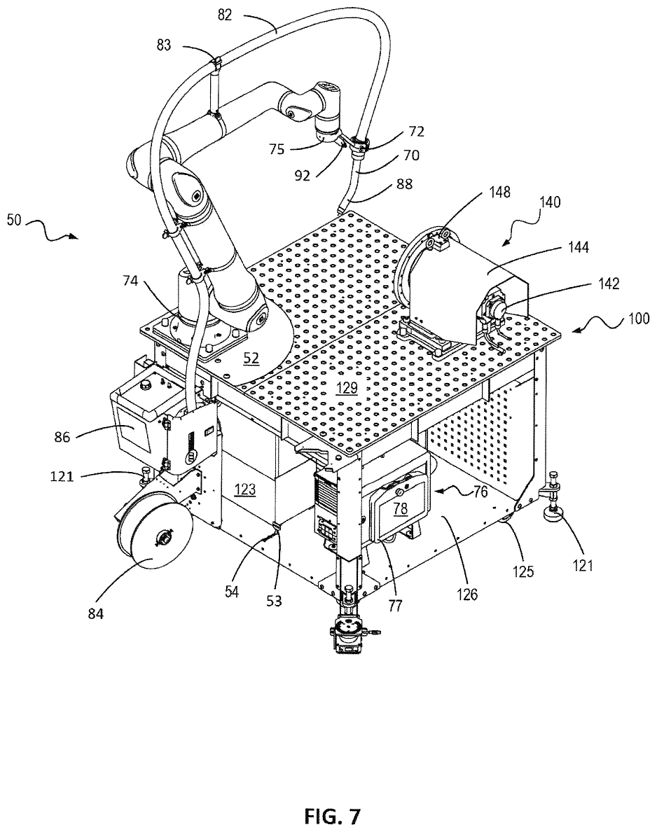

A programming or hand-guided jog button 92 is secured to the attachment 72 and is operatively connected to the robot controller and teach pendant and is adapted to allow an operator to set up and program the welding system in an intuitive and graphical manner. Shielding gas is delivered from a central gas supply system or from individual gas cylinders via the torch bundle to the weld nozzle, as is known in the art. Power is provided to the welding or cutting implement via power supply 95 mounted on the storage area or platform 124 of the cart 115 and secured thereto via one or more tabs 53, each of the one or more tabs being releasably inserted into and retained by a cooperating slot 54 formed in the platform 124, as shown in FIGS. 7-9. System cooling is provided by a water cooling apparatus 123 as may be needed for larger welding applications where generated heat may require faster dissipation than is available via air cooling. In an embodiment, a water cooling apparatus may also be mounted on storage area or platform 124. The power supply, robot controller, teach pendant, wire feed mechanism, and any ancillary power tools an operator may need all may be operatively connected to single phase power, for example, 120V power for the collaborative robot system and 240V power for the power supply. Optionally, the power supply may be connected to 208V, 480V or 575V three phase power.

As best shown in FIG. 7, a non-collaborative positioner 140 is mounted on the gridded upper work surface or table 129. The positioner includes an electric motor 142 covered by a protective shroud or hood 144 and having a spindle 146 adapted to rotate about axis A-A in response to programming commands from a positioner control system (not shown). A work holding plate 148 is operatively connected to the spindle and is adapted to receive work material holding fixtures or clamps to hold work material securely while cutting or welding operations are being performed on it.

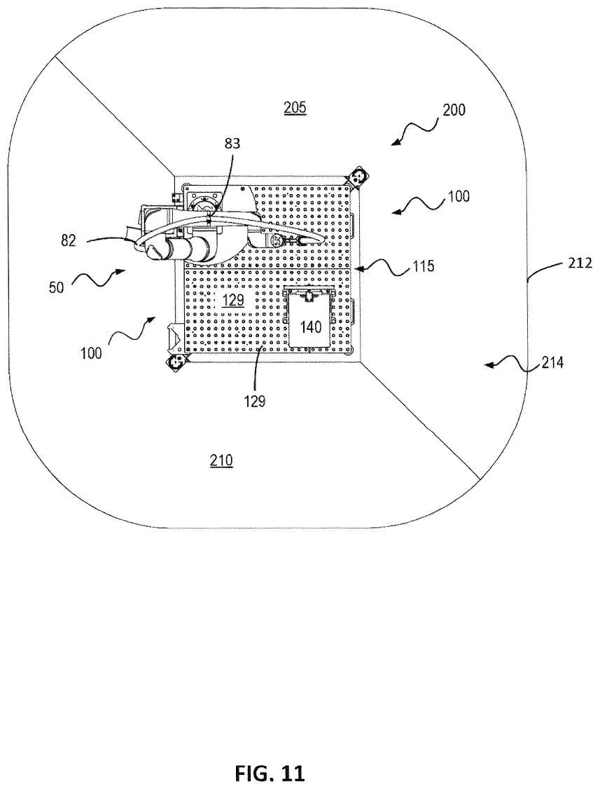

Referring now to FIGS. 11-13, the elements of a corner-mounted operator protection safety system 200, referred to hereinafter as “the LIDAR safety system or alternatively, the safety system”, as appropriate in the context is shown in greater detail. LIDAR is an acronym for light detection and ranging or, alternatively, laser imaging, detection, and ranging, a system which uses ultraviolet (UV), visible or near infrared (NIR) light to detect objects and to determine ranges or distances from the emitter/detector to the object. The LIDAR system of the corner-mounted operator protection safety system 200 of the instant invention is adapted to create or generate one or more preselected safety zones 205, 210, each extending partially around the collaborative robot welding system 200. The one or more preselected safety zones 205 and 210 cooperate to form or create a non-visible safety zone or safety barrier 212 which extends circumferentially around the collaborative robot welding system, thus creating a hybrid working environment 214 for an operator. The LIDAR system of the corner-mounted operator protection safety system is further adapted to detect the presence of an operator, other personnel, an object, or a vehicle such as a forklift in safety zone or barrier 212. These safety zones or barriers are shown in FIG. 11 and are generated by the LIDAR scan projected out by the system.

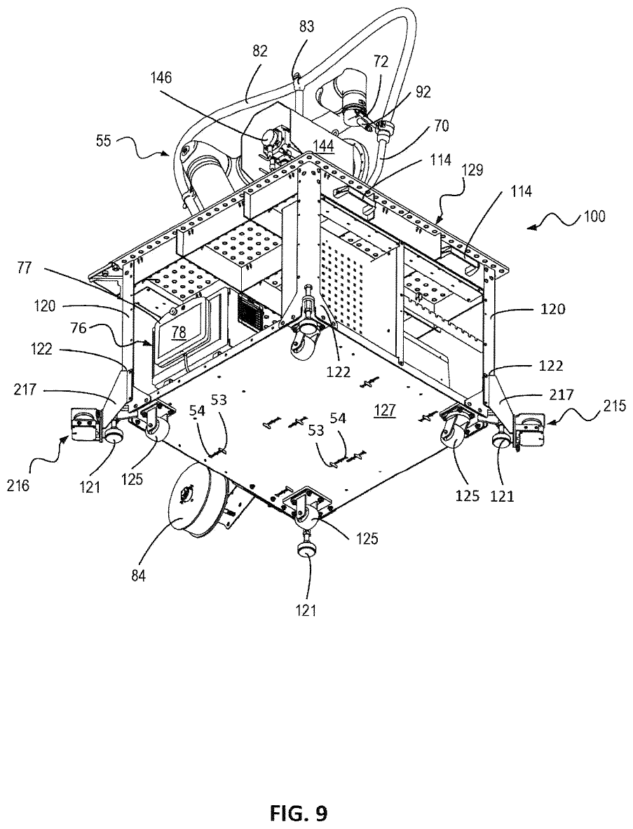

Referring to FIGS. 5 and 9, the components of the LIDAR system are illustrated in greater detail and include a pair of scan generating units, scanners, or projectors 215, 216 operatively connected to a lower portion 122 of each of diagonally opposite legs 120 of the frame 117 via brackets 217. The operating and control components of the system are self-contained within each of the generating units which are adjustably positionable to control the spread of the safety zones 205, 210 generated by the LIDAR safety system scan.

As noted above, the novel system of the present invention intergrades a non-collaborative positioner with the elements of a collaborative robot fabrication system, which includes a safety feature or system built into a robot control system and the robot arm itself, to create a hybrid working environment within the safety zone that allows for manipulation of complex parts while still allowing observation by a programmer or operator when the positioner is not moving. In operation, the safety feature built into the robot control system and the robot arm noted above works by monitoring multiple safety settings and limits simultaneously to ensure that the cobot's motion remains collaborative. Each axis of movement is equipped with a servo motor that is adapted to produce a specific power, momentum, and force and to limit these particular functions so that the servo motor does not exceed a specified limit. These measurements are also enhanced with simultaneous monitoring of a force/torque sensor that is integrated into the distal end of the cobot. The servo motor is also adapted to operate at a monitored speed which is usually a typical monitored safety function. However, a Universal Robots cobot can monitor multiple points simultaneously, by way of example, the elbow, flange, and end effector or torch tool center point (TCP) for a specific speed. All of these monitored speed locations are checked simultaneously, and the whole robot will slow down to keep that specific location within limits.

In operation, scanners 215 and 216 guard a respective portion of perimeter 212 of each of the safety zones 205, 210 thus allowing for distance and separation monitoring when the positioner 140 is moving. These scanners also allow the cobot to speed up for air moves in auto mode when the scanners are clear enabling more efficient programs since the main financial return for the system is when the cobot is welding or cutting. When the positioner is not moving and the program is not requesting a positioner move in auto mode, the programmer/operator can then walk up to the system as the cobot is welding or cutting. When the programmer/operator breaks the scanner perimeter 212 in this instance, the cobot will slow down when not welding or cutting. If the programmer/operator breaks the scanner in auto mode while the positioner is active and/or moving, the system will enter a safety fault state and stop both the positioner and the cobot, thereby preventing any unsafe situations. If the programmer/operator breaks the scanner perimeter and the program then comes to a move that is requesting the positioner to move, the teach pendant 77 will show a pop up message requesting the programmer/operator to leave the safety zone. Status lights on the robot will also flash in a specific color to indicate that the safety zone needs to be clear to continue.

When the system is in manual mode, the scanners are ignored and a 3-position enabling device takes their place as the safety chain for safety motion. The programmer must hold the 3-position enabling device for the positioner to be active or moving when running a program and if this device is released, the positioner will stop. The cobot will also be moving in a slower speed at all time when in manual mode to maintain the collaborative nature of the cobot.

When an object is detected in one of the zones, the operating speed of the robot system is reduced for safety purposes. Coupled with the built-in safety system of the robot arm, which stops its movement when the arm contacts an object, the system possesses dual chain safety feature redundancy. This feature also enhances production rates, inasmuch as the system may be operated confidently at higher speeds under normal conditions knowing that if an unsafe condition is detected, the system will respond proactively to protect the operator and other personnel in the area.

The availability of conventional shop power combined with the portability of the worktable contribute to the overall flexibility and adaptability of the welding system. It can be brought to the location of the work material and set up anywhere in a shop or in the field quickly with little lead time. The welding system of the foregoing embodiments mounted on the mobile platform or cart 115 occupies a small area having a reduced system footprint compared to conventional fully-platformed robots and does not require a large investment in utilities, dedicated factory space, safety guards and materials handling equipment. The welding system of the present invention is particularly adaptable for the fabrication of large assemblies having welded joints located in difficult to reach areas and at elevated positions.

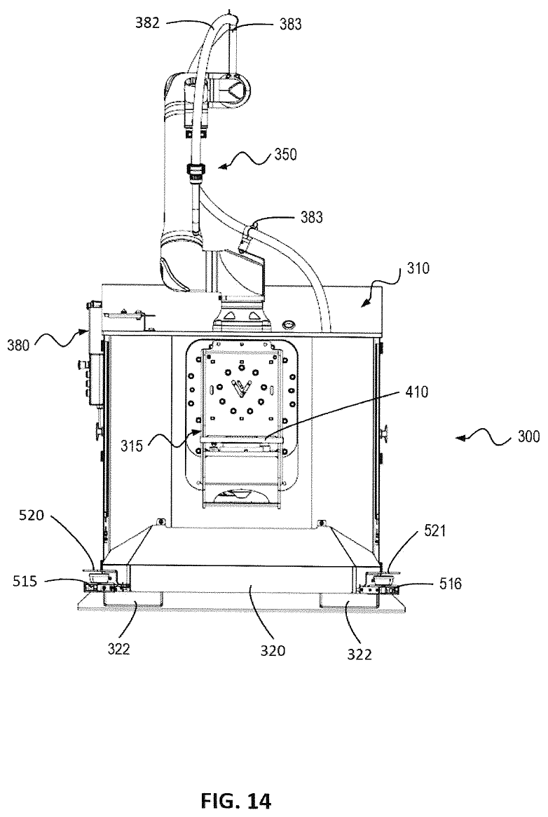

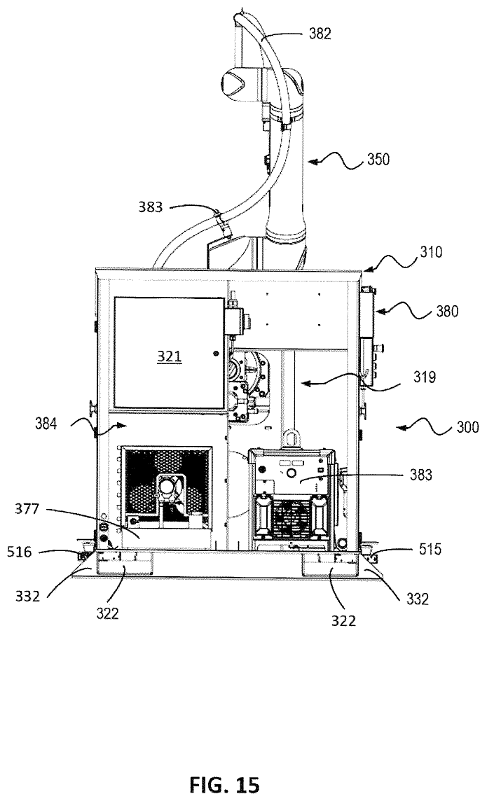

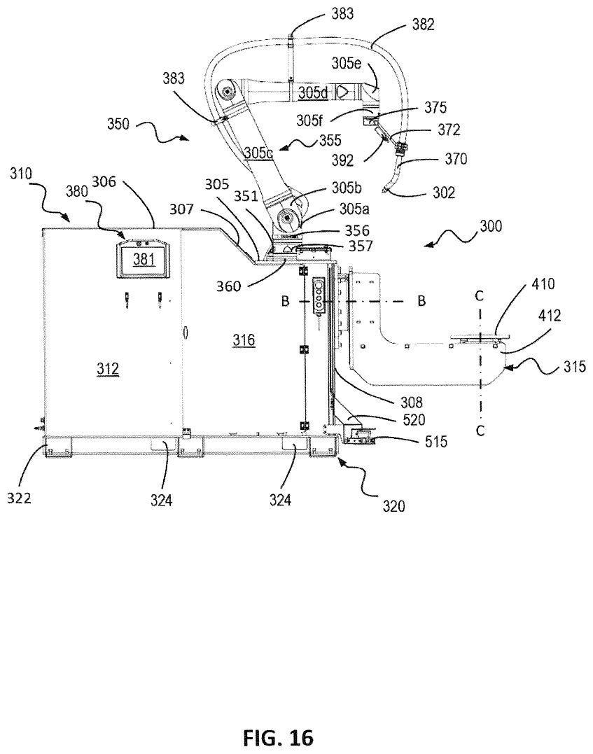

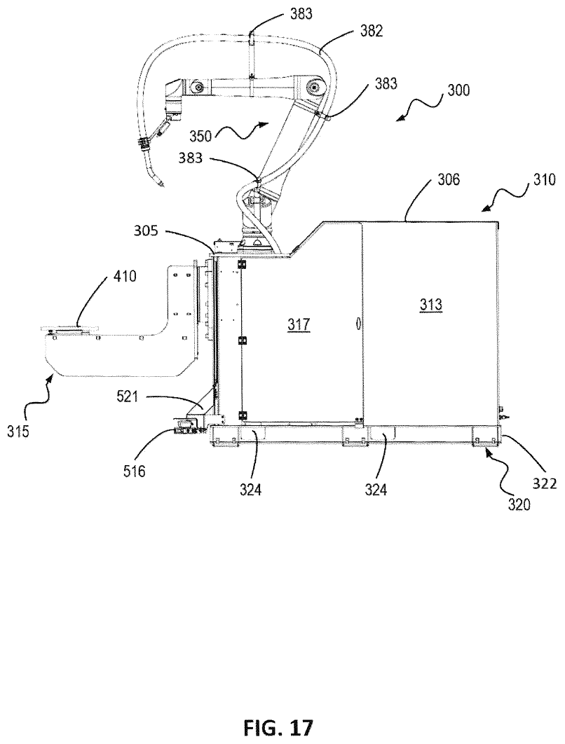

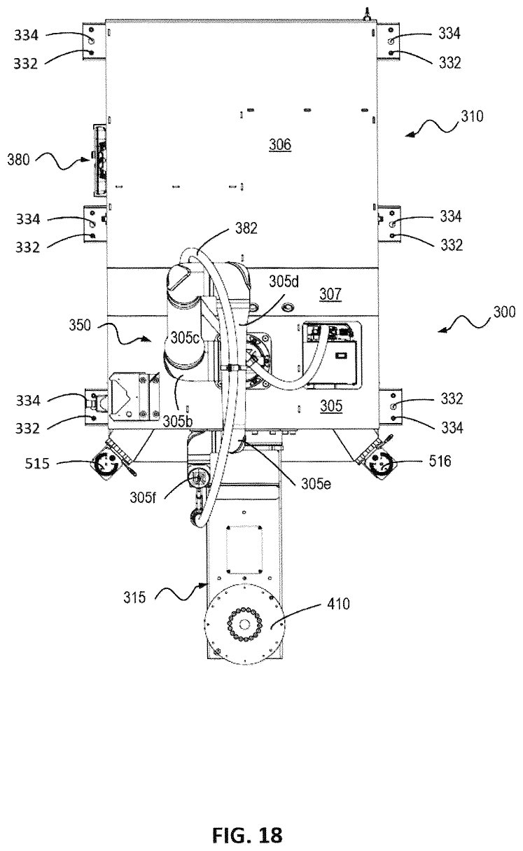

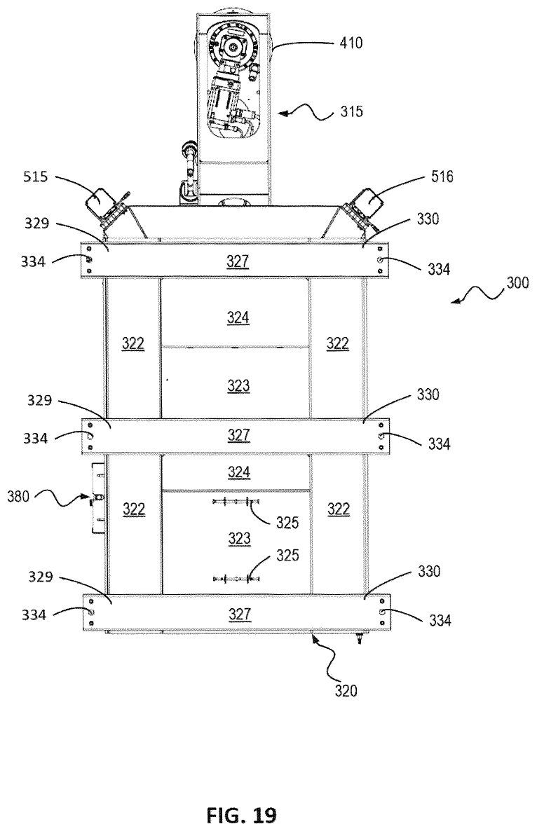

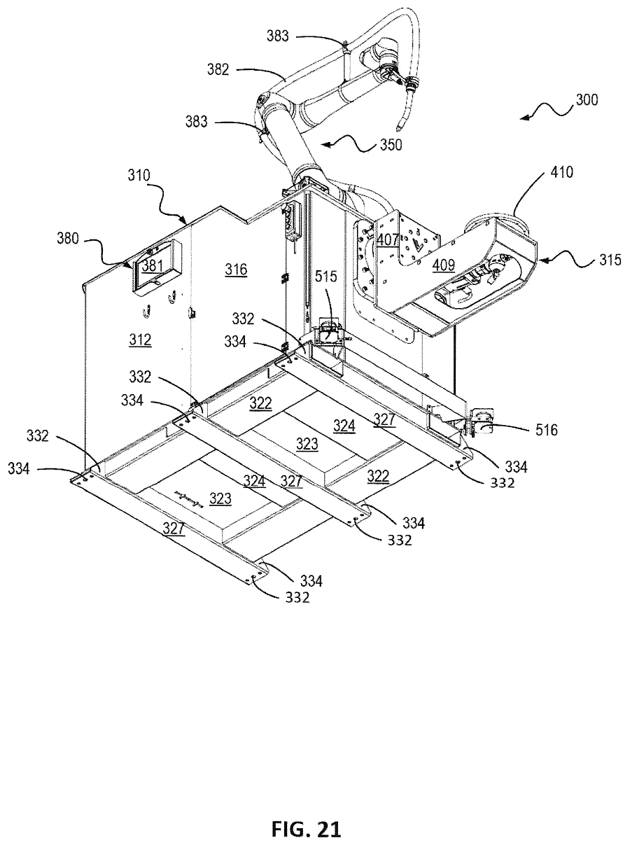

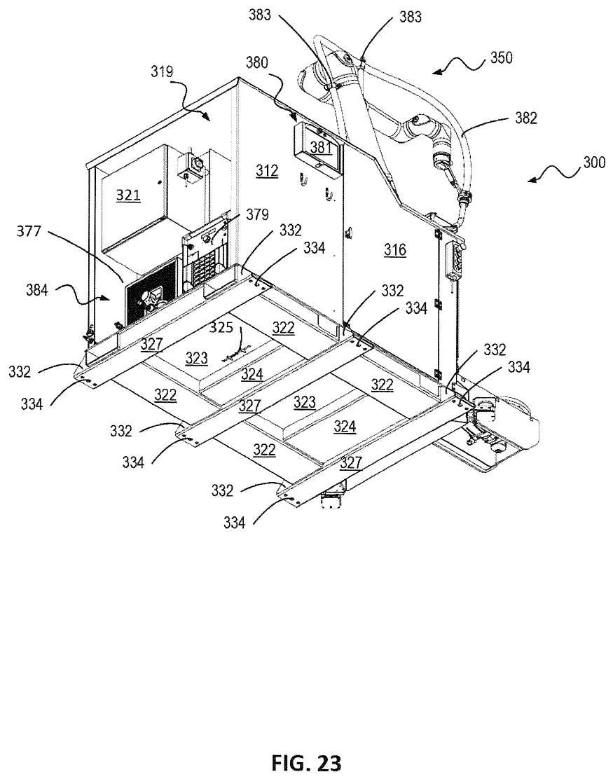

Referring now to FIGS. 14-25, the elements of a transportable collaborative robot fabrication system 300 having a programmable collaborative robot system or cobot 350 operatively secured to a first horizontally-extending top planar surface panel 305 of a movable or transportable platform or base 310. In the embodiment shown, the movable or transportable platform or base is in the form of a supporting cabinet 310; however, it is to be understood that other forms of movable platforms such as carts or skids may be used without departing from the scope of the present invention. The cabinet further includes a second horizontally-extending top planar surface panel 306 and an inclined top surface panel 307 disposed intermediate the first and second horizontally-extending top planar surface panels 305 and 306. The supporting cabinet 310 further includes left and right side panels 312 and 313, each panel further having an access door 316, 317 respectively formed therein to provide access to the system components housed within the cabinet, and a lower or bottom frame 320 in the form of a floor panel 323 having one or more T-slots 325 formed therein, the floor panel being supported by at least two longitudinally and transversely extending channels 322, 324 respectively, and a plurality of transversely extending support plates 327, as best viewed in FIGS. 19, 21, and 23. Each of the transversely extending support plates 327 includes a first end portion 329 and a second end portion 330, each of the first and second end portions having a bracket 332 operatively connected thereto or integrally formed therein. Each of the brackets 332 further includes a plurality of apertures 334 formed therein, each of the plurality of apertures being adapted to receive a fastener adapted to secure each of the support plates and the transportable collaborative robot fabrication system to a supporting surface as needed for a particular application. Each channel is adapted to receive a lift truck fork member for transporting the system to a desired location. The top surface panels, the front and rear panels, the side panel, the floor panel, and the lower or bottom frame cooperate to define an interior storage compartment 319 adapted to house system components therein as noted above.

The transportable collaborative robot fabrication system 300 includes a non-collaborative dual axis work holding positioner 315 operatively secured to the side surface or panel 308 of the movable or transportable platform or base in accordance with an embodiment of the present invention, the structure and function of which will be described in greater detail below. The collaborative robot fabrication system 300 further includes a collaborative robot system 350 (known in the art as a cobot), such as a Universal Robots™ UR10e collaborative industrial robot. However, it is to be understood that collaborative robot systems either specifically designed and built for individual applications or other generally commercially available collaborative robot systems may also be used without departing from the scope of the present invention. The collaborative robot system comprises a robot arm 355 having a proximal end 356 and a distal end 375. The proximal end 356 is operatively connected to a base 357, which, in turn, is mounted on an electrically isolating pad 360 secured by suitable fasteners 351 to the first top planar surface 305 of the supporting cabinet 310. The robot arm includes a plurality of arm segments 365a-365f sequentially pivotally and/or rotatably interconnected to one another and structured and arranged to have a reach length or distance which depends upon the size of the robot arm selected for use in the system 300 and the lengths of its individual segments. A built-in safety feature (not shown) in the robot arm is structured and arranged to interrupt movement of the arm, should it come in contact with the operator or another object. A welding or cutting implement or torch 370 is secured via an attachment 372 to a distal end 375 of the robot arm, the implement being universally positionable and translatable along a preselected weld or cut path in response to instructions from a robot controller 379, teach pendant 380, and an application programming interface (API) display 381. In the embodiments of FIGS. 14-25, by way of example and not of limitation, the implement 370 is depicted in the form of a welding torch representative of the type used in Gas Metal Arc Welding (GMAW) processes; however, it is to be understood that the system of the present invention may be used with any materials joining or cutting process without departing from the scope of the present invention. It is to be understood that the system 300 may be used for cutting applications by replacing the welding implement 370 with a plasma cutting torch or other cutting implements needed for a particular cutting application.

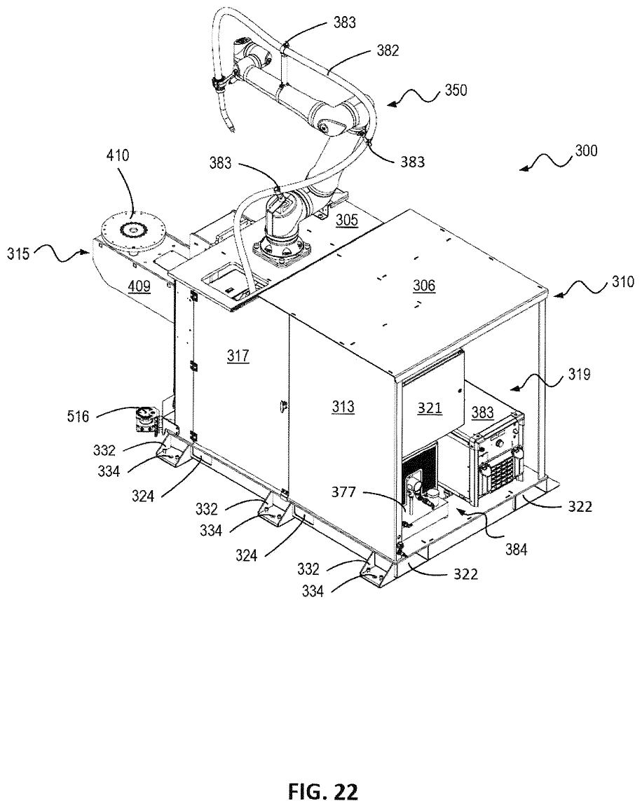

Welding consumables such as protective shielding gas, cutting gas, granular flux material and welding wire are delivered to the welding implement via conduit or welding torch bundle 382 secured to the robot arm by conduit or bundle management brackets 383. Similar in structure and operation to the embodiment of FIG. 1, the wire is stored in a suitable wire storage apparatus such as a drum or, by way of example and not of limitation, on a wire spool and fed by a wire feed mechanism from the spool through the conduit or bundle 382 and to a weld joint assembly via the welding torch or nozzle 302. In the embodiment of FIGS. 14-25, a power supply 383, wire spool, wire feed mechanism, and other system equipment shown generally at 384 in FIG. 22 are housed within the interior storage compartment 319.

A programming or hand-guided jog button 392 is secured to the attachment 372 and is operatively connected to the robot controller (not shown), teach pendant 380 and the API display 381 and is adapted to allow an operator to set up and program the welding system in an intuitive and graphical manner. Shielding gas is delivered from a central gas supply system or from individual gas cylinders via the torch bundle to the weld nozzle, as is known in the art. Power is provided to the welding or cutting implement via the power supply 383 mounted in the supporting cabinet, and system cooling is provided by a water cooling apparatus XXX as may be needed for larger welding applications where generated heat may require faster dissipation than is available via air cooling. In an embodiment, a water cooling apparatus may also be mounted on a storage area or platform within the interior storage compartment 319. The power supply, robot controller, teach pendant, wire feed mechanism, and any ancillary power tools an operator may need all may be operatively connected to single phase power, for example, 120V power for the collaborative robot system and 240V power for the power supply. Optionally, the power supply may be connected to 208V, 480V or 575V three phase power. Unlike the system 100 of FIG. 1, the system 300 of FIG. 14 does not have wheels or castors secured to a bottom surface of a supporting frame. Rather, the supporting cabinet 310 of the embodiment of FIG. 1 includes the lower or bottom frame 320 in the form of at least two longitudinally and transversely extending channels 322, 324 respectively, as best viewed in FIG. 19 and as hereinabove described, each channel being adapted to receive a lift truck fork member for transporting the system to a desired location.

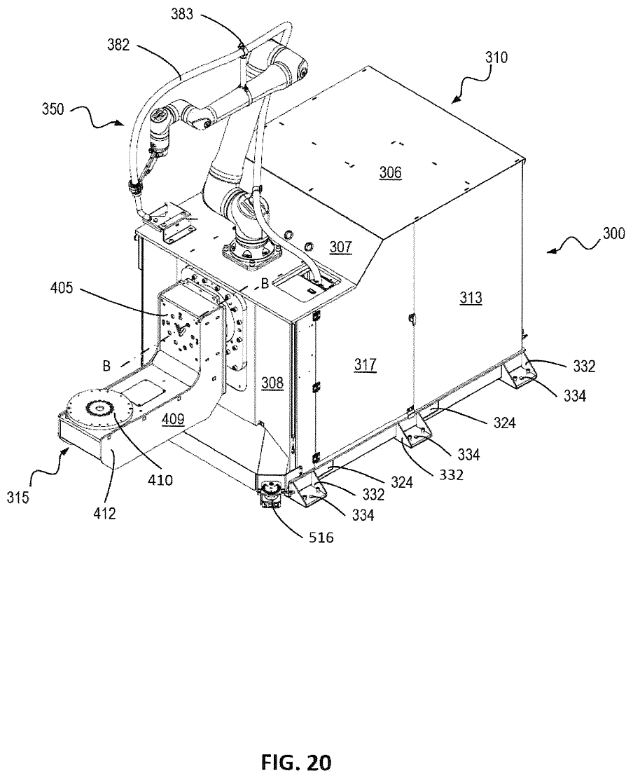

As best shown in FIG. 20, the non-collaborative positioner 315 is mounted on a side panel 308 of the cabinet 310 and is adapted to cooperate with the operator protection safety system and the safety feature built into the robot control system and the robot arm to create a hybrid working environment for an operator. The positioner includes an L-shaped body 405 having a vertically extending member 407 and a horizontally extending member 409, the L-shaped body 405 being adapted to rotate about axis B-B in response to programming commands from a positioner control system (not shown). A work holding plate 410 is operatively connected to a distal end 412 of the horizontally extending member 409 and is adapted to receive work material holding fixtures or clamps to hold work material securely while cutting or welding operations are being performed on it. The work holding plate is further adapted to rotate about axis C-C and is driven by a shaft and gear mechanism housed within the L-shaped body 405 as is known in the art. In the embodiment shown, axis C-C is perpendicular to axis B-B; however, it is to be understood that the angle between the two axes may vary depending upon the application without departing from the scope of the instant invention.

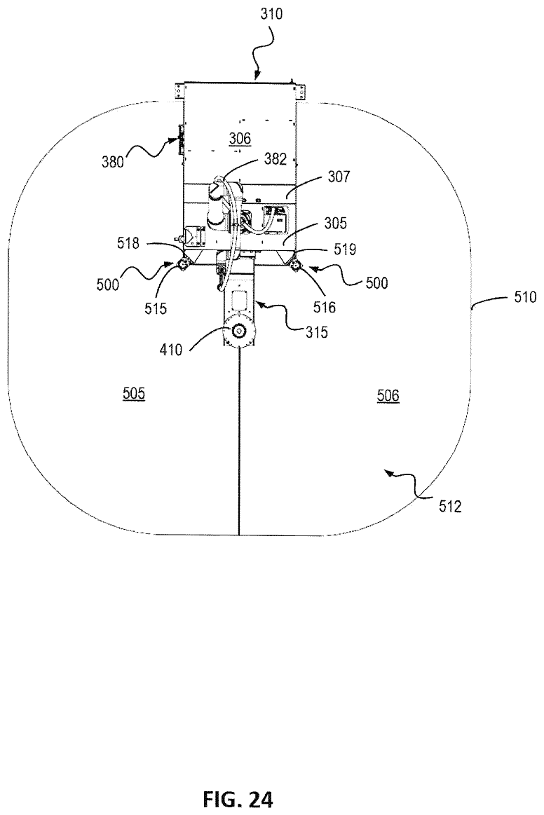

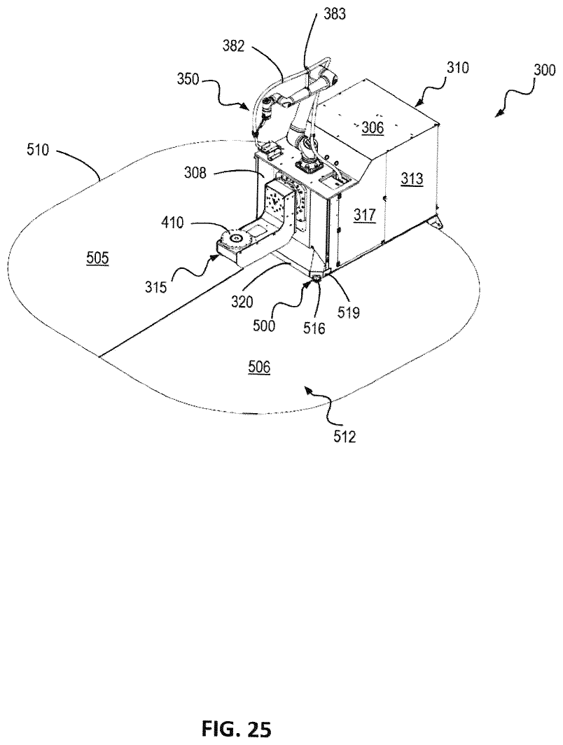

Referring now to FIGS. 24-25, the elements of a corner-mounted operator protection safety system 500, referred to hereinafter as “the LIDAR safety system or alternatively, the safety system”, as appropriate in the context is shown in greater detail. The LIDAR system of the corner-mounted operator protection safety system 500 of the embodiment of FIGS. 24-25 is identical in operation as the system 200 described above. LIDAR system 500 is adapted to create or generate one or more preselected safety zones 505, 506, each extending partially around the collaborative robot welding system 200. The one or more preselected safety zones 505 and 506 cooperate to form or create a non-visible safety zone or safety barrier 510 which extends y around the collaborative robot welding system, thus creating a hybrid working environment 512 for an operator. The LIDAR system of the corner-mounted operator protection safety system is further adapted to detect the presence of an operator, other personnel, an object, or a vehicle such as a forklift in safety zone or barrier 510. and is used to detect the presence of an operator, other personnel or a vehicle such as a forklift in a preselected safety zone 505 or 506 surrounding the collaborative robot welding system 300.

Referring to FIGS. 14-17, the components of the LIDAR system are illustrated in greater detail and include a pair of scan generating units, scanners, or projectors 515, 516 operatively connected to first and second corners 518 and 519 respectively of the lower portion 320 of a right side portion of the frame of the supporting cabinet 310 via brackets 520, 521, respectively. The operating and control components of the system are self-contained within each of the generating units which are adjustably positionable to control the spread of the safety zones 505 and 506 generated by the LIDAR safety system scan.

As noted above, the novel system of the present invention intergrades a non-collaborative positioner with a collaborative robot, the non-collaborative positioner and collaborative robot cooperating to create a hybrid working environment 512 that allows for manipulation of complex parts while still allowing observation by a programmer or operator when the positioner is not moving. In operation, scanners 515 and 516 guard a respective portion of perimeter 510 of the safety zone 505, thus allowing for distance and separation monitoring when the positioner 315 is moving. These scanners also allow the cobot to speed up for air moves in auto mode when the scanners are clear enabling more efficient programs since the main financial return for the system is when the cobot is welding or cutting. When the positioner is not moving and the program is not requesting a positioner move in auto mode, the programmer/operator can then walk up to the system as the cobot is welding or cutting. When the programmer/operator breaks the scanner perimeter 510 in this instance, the cobot will slow down when not welding or cutting. If the programmer/operator breaks the scanner in auto mode while the positioner is active and/or moving, the system will enter a safety fault state and stop both the positioner and the cobot, thereby preventing any unsafe situations. If the programmer/operator breaks the scanner perimeter and the program then comes to a move that is requesting the positioner to move, the teach pendant 380 will show a pop up message requesting the programmer/operator to leave the safety zone. Status lights on the robot will also flash in a specific color to indicate that the safety zone needs to be clear to continue.

When the system is in manual mode, the scanners are ignored and a 3-positon enabling device on the teach pendant takes their place as the safety chain for safety motion. The programmer must hold the 3-position enabling device for the positioner to be active or moving when running a program and if this device is released, the positioner will stop. The cobot will also be moving in a slower speed at all time when in manual mode to maintain the collaborative nature of the cobot.

When an object is detected in one of the zones, the operating speed of the robot system is reduced for safety purposes. Coupled with the built-in safety system of the robot arm, which stops its movement when the arm contacts an object, the system possesses dual chain safety feature redundancy. This feature also enhances production rates, inasmuch as the system may be operated confidently at higher speeds under normal conditions knowing that if an unsafe condition is detected, the system will respond proactively to protect the operator and other personnel in the area.

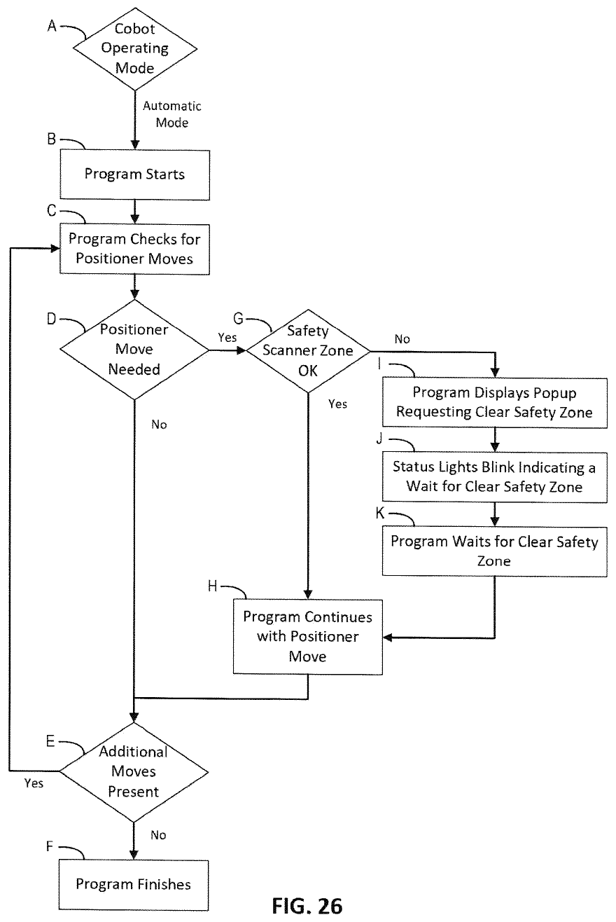

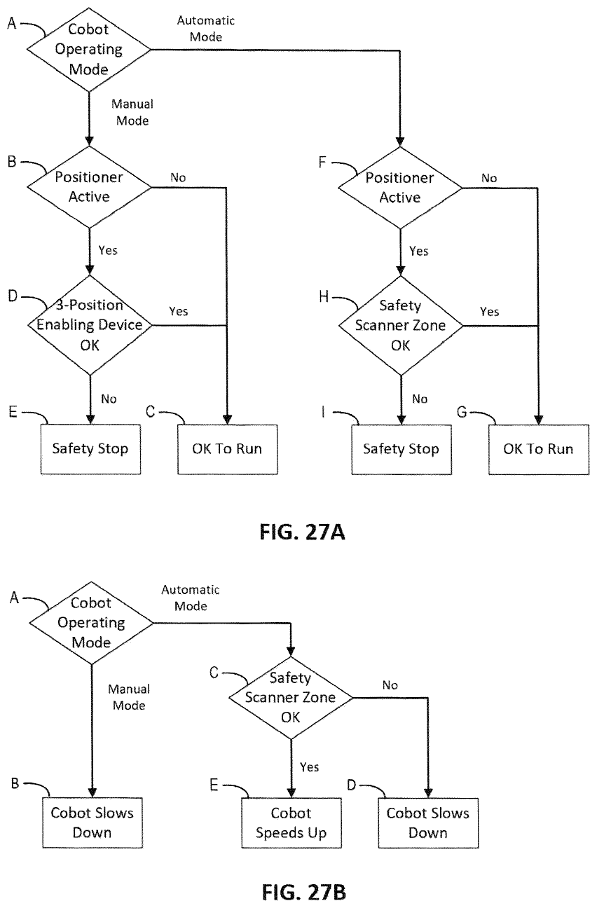

Referring now to the flow diagrams of FIGS. 26, 27A, and 27B the workflow and operational sequences of material processing of both embodiments of the present invention are presented in detail. More specifically, FIG. 26 sets forth the sequence of operation of the operating steps of a collaborative robot systems of FIGS. 1 and 14 are shown illustrating system response steps to an interruption of the safety zone perimeter in accordance with an embodiment of the present invention. At step A, the operator places the cobot in the automatic operating mode and initiates the desired program sequence at step B. At step C, the operating program checks for required movements of the non-collaborative positioner. If none are required, the sequence transitions to step E where the system tests for any additional required moves. If none are required, the program finishes at step F. If the system detects that additional moves are required, the sequence returns to step C where again, it checks for positioner moves and the process sequence repeats.

If the system detects that positioner moves are required at step D, at step G, the safety zones generated by the LIDAR safety system are scanned to detect the presence of an operator, other personnel, an object, or a vehicle therein. If the safety zones are clear, the program sequence returns to step H and continues with the required positioner move. If the programmer/operator breaks the scanner while the positioner is active and/or moving, at step I, the system will enter a safety fault state and stop both the positioner and the cobot, thereby preventing any unsafe situations. If the programmer/operator breaks the scanner perimeter and the program then comes to a move that is requesting the positioner to move, at step I and J, the teach pendant will show a pop up message requesting the programmer/operator to leave the safety zone and status lights will blink indicating a positioner move is needed. After the safety zones are cleared, at step K, the program sequence returns to step H and then continues until either additional moves are detected or until the program sequence is completed at step F.

Referring now to FIGS. 27A and 27B, the operating sequence steps of the collaborative robot fabrication systems of FIGS. 1-25 in automatic and manual modes when the system includes a non-collaborative positioner in accordance with an embodiment of the present invention. Initially referring to FIG. 27A, at step A, an operator selects the operating mode of the system, either automatic mode or manual mode. If manual mode is selected, at step B, the non-collaborative positioner is checked for either active or inactive status. If the positioner is inactive, at step C, the operator may proceed with the required fabrication operation to be performed. If the non-collaborative positioner is determined to be active at step B, at step D, a 3-position enabling device is checked to determine if the 3-position enabling device is active. If the 3-position enabling device is active, the operator may proceed to step C and proceed with the required fabrication operation to be performed. If at step D the 3-position enabling device is determined to be inactive, at step E, the system is stopped and the required fabrication operation may not be performed.

Returning to step A, if an operator selects the automatic mode, at step F, the non-collaborative positioner is checked for either active or inactive status. If the positioner is inactive, at step G, the operator may proceed with the required fabrication operation to be performed. If the non-collaborative positioner is determined to be active at step F, at step H, the safety zones generated by the LIDAR safety system are scanned to detect the presence of an operator, other personnel, an object, or a vehicle in the safety zones. If none are detected, the operator may proceed to step G and proceed with the required fabrication operation to be performed. If at step H, an operator, other personnel, an object, or a vehicle is detected in the safety zones at step I, the system is stopped and the required fabrication operation may not be performed.

Referring now to FIG. 27B, the operating sequence steps of the collaborative robot fabrication systems of FIGS. 1-25 in automatic and manual modes are illustrated in accordance with an embodiment of the present invention when the system does not include a non-collaborative positioner or if a non-collaborative positioner is disengaged or inoperative. If an operator selects manual mode at step A, when the positioner is not moving and the program is not requesting a positioner move in auto mode, when the programmer/operator breaks the scanner perimeter in this instance, at step B, the cobot will slow down when not welding or cutting. If the automatic mode is selected at step A, at step C, the safety zones generated by the LIDAR safety system are scanned to detect the presence of an operator, other personnel, an object, or a vehicle in the safety zones. If the presence of an operator, other personnel, an object, or a vehicle in the safety zones is detected, the cobot is slowed down at step D. If no operator, other personnel, an object, or a vehicle is detected in the safety zones is detected at step C, the cobot is sped up at step E.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A highly-mobile collaborative robot fabrication system comprising:
a mobile platform;
at least one programmable collaborative robot system operatively connected to the mobile platform;
a material processing implement operatively connected to the at least one programmable collaborative robot;
a power supply operatively connected to the material processing implement;
a robot control system;
a non-collaborative positioner operatively connected to the mobile platform; and
an operator protection safety system adapted to create or generate one or more preselected safety zones surrounding the collaborative robot fabrication system, the one or more preselected safety zones being adapted to form or create a non-visible safety zone or safety barrier extending circumferentially around the collaborative robot fabrication system, the operator protection safety system being further adapted to detect the presence of an operator, other personnel, an object, or a vehicle such as a forklift in the circumferentially extending safety zone or barrier, whereby a hybrid working environment is created within the circumferentially extending safety zone or safety barrier.

2. The highly-mobile collaborative robot fabrication system of claim 1 wherein the mobile platform includes a frame, a plurality of supporting legs operatively connected to the frame, each of the plurality of supporting legs including a levelling device or foot operatively connected thereto, a bottom or lower storage area or platform operatively connected to each of the plurality of supporting legs, the bottom or lower storage area or platform including an upper or top surface, a lower or bottom surface, and a plurality of wheels or casters secured to the bottom surface, a gridded upper work surface or table, and one or more handles operatively connected to the frame and extending outwardly therefrom, the handles being adapted to permit an operator to move the system to a designated location for performing fabrication operations.

3. The highly-mobile collaborative robot fabrication system of claim 2 wherein the gridded upper work surface or table includes a plurality of apertures formed therein, each of the apertures being adapted to releasably receive a clamp or other securement device for holding a workpiece, fixture or weld assembly in a fixed position during the performance of a fabrication operation.

4. The highly-mobile collaborative robot fabrication system of claim 3 wherein the at least one programmable collaborative robot system comprises a robot arm having a proximal end and a distal end, the robot arm including a plurality of arm segments sequentially pivotally and/or rotatably interconnected to one another and adapted to have a preselected reach length; a first base operatively connected to the robot arm's proximal end; a second base secured to or formed integrally with the table; and an electrically isolating pad adapted to be positioned intermediate the first and second bases and the gridded upper work surface or table.

5. The highly-mobile collaborative robot fabrication system of claim 4 wherein the at least one programmable collaborative robot includes a safety feature built into the robot control system and the robot arm, the safety feature being adapted to interrupt movement of the robot arm, should it come in contact with an operator or another object.

6. The highly-mobile collaborative robot fabrication system of claim 4 wherein the robot control system includes a teach pendant, an application programming interface (API) display, and a programming or hand-guided jog button operatively connected to the distal end of the robot arm, the robot controller, and the teach pendant, the programming or hand-guided jog button being adapted to allow an operator to set up and program the welding system in an intuitive and graphical manner.

7. The highly-mobile collaborative robot fabrication system of claim 5 wherein the operator protection safety system comprises a corner-mounted LIDAR system adapted to create or generate one or more preselected safety zones, each of the one or more preselected safety zones extending partially around the collaborative robot fabrication system, the one or more preselected safety zones cooperating with one another to form or create a non-visible safety zone or safety barrier extending circumferentially around the collaborative robot welding system.

8. The highly-mobile collaborative robot fabrication system of claim 7 wherein the LIDAR system includes a pair of scan generating units, scanners, or projectors operatively connected to a lower portion of each of diagonally opposite legs of the frame, a bracket adapted to operatively and adjustably connect each of the pair of scan generating units, scanners, or projectors to a respective one of the diagonally opposite legs of the frame, whereby each of the pair of scan generating units, scanners, or projectors are adjustably positionable to control the spread of each of the one or more preselected safety zones generated by the LIDAR safety system scan.

9. The highly-mobile collaborative robot fabrication system of claim 8 wherein the operator protection safety system and the safety feature built into the robot control system and the robot arm cooperate with one another to create a hybrid working environment for an operator.

10. The highly-mobile collaborative robot fabrication system of claim 9 further including a non-collaborative positioner mounted on the gridded upper work surface or table and adapted to receive work material holding fixtures or clamps to hold work material securely while fabrication operations are being performed on the work material and to cooperate with the operator protection safety system and the safety feature built into the robot control system and the robot arm to create a hybrid working environment for an operator.

11. The highly-mobile collaborative robot fabrication system of claim 1 wherein the material processing implement comprises a welding implement.

12. The highly-mobile collaborative robot fabrication system of claim 1 wherein the material processing implement comprises a cutting implement.

13. A transportable collaborative robot fabrication system comprising:
a movable platform;
at least one programmable collaborative robot system operatively connected to the movable platform;
a material processing implement operatively connected to the at least one programmable collaborative robot;
a power supply operatively connected to the material processing implement;
a robot control system;
a non-collaborative dual axis positioner operatively connected to the movable platform; and
an operator protection safety system adapted to create or generate one or more preselected safety zones surrounding the collaborative robot fabrication system, the one or more preselected safety zones being adapted to form or create a non-visible safety zone or safety barrier extending around a preselected portion of the collaborative robot fabrication system, the operator protection safety system being further adapted to detect the presence of an operator, other personnel, an object, or a vehicle such as a forklift in the safety zone or barrier, whereby a hybrid working environment is created within the circumferentially extending safety zone or safety barrier.

14. The transportable collaborative robot fabrication system of claim 13 wherein the movable platform comprises a cabinet, the cabinet including first and second horizontally-extending top planar surfaces, an inclined top surface panel disposed intermediate the first and second horizontally-extending top planar surface panels, a front panel, a rear panel, an access door formed in each of the front and rear panels, a side panel, a floor panel, and a lower or bottom frame, the top surface panels, the front and rear panels, the side panel, the floor panel, and the lower or bottom frame being structured and arranged to define an interior storage compartment adapted to house system components therein.

15. The transportable collaborative robot fabrication system of claim 14 wherein the lower or bottom frame includes a floor panel, at least two longitudinally and two transversely extending channels respectively, and a plurality of transversely extending support plates, each of the transversely extending support plates further including a first end portion and a second end portion, each of the first and second end portions having a bracket operatively connected thereto or integrally formed therein, each of the brackets including a plurality of apertures formed therein, each of the plurality of apertures being configured to receive a fastener adapted to secure each of the support plates and the transportable collaborative robot fabrication system to a supporting surface.

16. The transportable collaborative robot fabrication system of claim 15 wherein the programmable collaborative robot system or cobot comprises a robot arm having a proximal end and a distal end, the robot arm including a plurality of arm segments sequentially pivotally and/or rotatably interconnected to one another and adapted to have a preselected reach length; a base operatively connected to the robot arm's proximal end; and an electrically isolating pad adapted to be positioned intermediate the base and the first top planar surface of the supporting cabinet.

17. The transportable collaborative robot fabrication system of claim 16 wherein the at least one programmable collaborative robot includes a safety feature built into the robot control system and the robot arm, the safety feature being adapted to interrupt movement of the robot arm, should it come in contact with an operator or another object.

18. The transportable collaborative robot fabrication system of claim 17 wherein the robot control system includes a teach pendant, an application programming interface (API) display, and a programming or hand-guided jog button operatively connected to the distal end of the robot arm, the robot controller, and the teach pendant, the programming or hand-guided jog button being adapted to allow an operator to set up and program the welding system in an intuitive and graphical manner.

19. The transportable collaborative robot fabrication system of claim 18 further including a non-collaborative positioner mounted on the side panel of the cabinet, the non-collaborative positioner being adapted to cooperate with the operator protection safety system and the safety feature built into the robot control system and the robot arm to create a hybrid working environment for an operator, the non-collaborative positioner including an L-shaped body having a vertically extending member and a horizontally extending member, the L-shaped body being adapted to rotate about a first axis in response to programming commands from a positioner control system, the non-collaborative positioner further including a work holding plate operatively connected to a distal end of the horizontally extending member, the work holding plate being adapted to rotate about a second axis and to receive work material holding fixtures or clamps configured to hold work material securely while fabricating operations are being performed thereon.

20. The transportable collaborative robot fabrication system of claim 19 wherein the operator protection safety system comprises a corner-mounted LIDAR system adapted to create or generate one or more preselected safety zones, each of the one or more preselected safety zones extending partially around the collaborative robot fabrication system, the one or more preselected safety zones cooperating with one another to form or create a non-visible safety zone or safety barrier extending around the collaborative robot welding system.

21. The transportable collaborative robot fabrication system of claim 20 wherein the LIDAR system includes a pair of scan generating units, scanners, or projectors operatively connected to first and second corners respectively of a lower right side portion of the frame of the supporting cabinet, the pair of scan generating units, scanners, or projectors adjustably positionable to control the spread of the safety zones generated by the LIDAR safety system scan.

22. The transportable collaborative robot fabrication system of claim 13 wherein the material processing implement comprises a welding implement.

23. The transportable collaborative robot fabrication system of claim 13 wherein the material processing implement comprises a cutting implement.

24. A method for operating a highly-mobile collaborative robot fabrication system having a non-collaborative positioner in automatic mode comprising the steps of:
Step A, the operator places the cobot in the automatic operating mode;
Step B, the operator initiates the desired program sequence;
Step C, the operating program checks for required movements of the non-collaborative positioner;
Step D, if the system determines that no non-collaborative positioner moves are required, the sequence transitions to Step E;
Step E, the system tests for any additional required non-collaborative positioner moves;
if no additional non-collaborative positioner moves are required, the sequence transitions to Step F; if additional non-collaborative positioner moves are required, the sequence transitions back to Step C;
Step F, the program finishes;
Step G, if the system detects that positioner moves are required at Step D, at Step G, the safety zones generated by the LIDAR safety system are scanned to detect the presence of an operator, other personnel, an object, or a vehicle therein; if the safety zones are not clear while the non-collaborative positioner is active, the program sequence transitions to Step I;
Step H, if the safety zones are clear, the sequence continues with the required positioner move, progresses to Step E and tests for any additional required non-collaborative positioner moves; if no additional non-collaborative positioner moves are required, the sequence transitions to Step F;
Step I, the system will enter a safety fault state and stop both the positioner and the cobot, thereby preventing any unsafe situations and progress to Step J;
Step J, the teach pendant displays a pop up message requesting the programmer/operator to leave the safety zone and status lights will blink indicating a positioner move is needed;
Step K, the program pauses and waits for the safety zone to be cleared and then progresses to Step H and then continues until either additional moves are detected or until the program sequence is completed at step F.

25. A method for operating a highly-mobile collaborative robot fabrication system having a non-collaborative positioner in automatic and manual modes comprising the steps of:
Step A, an operator selects the operating mode of the system, either automatic mode or manual mode;
Step B, if manual mode is selected at Step A, the non-collaborative positioner is checked for either active or inactive status;
Step C, if the non-collaborative positioner is determined to be inactive at Step B, the operator may proceed to Step C and perform the required fabrication operation; to be performed;
Step D, if the non-collaborative positioner is determined to be active at Step B, at Step D, a 3-position enabling device is checked to determine if it is active. If the 3-position enabling device is active, the operator may proceed to Step C and proceed with the required fabrication operation to be performed;
Step E, if at Step D the 3-position enabling device is determined to be inactive, at Step E, the system is stopped and the required fabrication operation may not be performed;
Returning to Step A, if an operator selects the automatic mode, the program progresses to Step F;
Step F, the non-collaborative positioner is checked for either active or inactive status; if it is in inactive status, the sequence progresses to Step G;
Step G, the operator may proceed with the required fabrication operation to be performed;
Step H, the non-collaborative positioner is in active status at Step F, the sequence progresses to Step H where the safety zones generated by the LIDAR safety system are scanned to detect the presence of an operator, other personnel, an object, or a vehicle in the safety zones. If none are detected, the sequence progresses to Step G;
Step I, if at Step H, an operator, other personnel, an object, or a vehicle is detected in the safety zones, at Step I, the system is stopped and the required fabrication operation may not be performed.

26. A method for operating a highly-mobile collaborative robot fabrication system in automatic and manual modes when the system does not have a non-collaborative positioner or if a non-collaborative positioner is disengaged or inoperative, the method comprising the steps of:
Step A, an operator selects the operating mode of the system, either automatic mode or manual mode; the operator places the cobot in the automatic operating mode;
Step B, the operator initiates the program sequence in manual mode, at Step B if the non-collaborative positioner is not moving and the program is not requesting a positioner move in auto mode, when the programmer/operator breaks the scanner perimeter in this instance, at Step B, the cobot will slow down when not performing fabrication operations;
Step C, if the operator initiates the program sequence in automatic mode, at Step C, the safety zones generated by the LIDAR safety system are scanned to detect the presence of an operator, other personnel, an object, or a vehicle in the safety zones;
Step D, if the presence of an operator, other personnel, an object, or a vehicle in the safety zones is detected, the cobot is slowed down at Step D;
Step E, if no operator, other personnel, an object, or a vehicle is detected in the safety zones is detected at step C, the cobot is sped up at Step E.
